(19) United States
(12) Patent Application Publication
(10) Pub. No.: US 2008/0301998 A1
(43) Pub. Date: Dec. 11, 2008

(54) Fish Hook Remover

(76) Inventor: John Gallo, (US)

Correspondence Address: John Gallo, 764 St. Mary's Road, Lafayette, CA, 94549, US

(21) Appl. No.: 11/760,360

(22) Filed: Jun. 8, 2007

(51) Int. Cl. A01K 97/18

(52) U.S. Cl. 43/53.5

(57) ABSTRACT

A fish hook remover, designed to minimize damage to an artificial fly and to minimize and reduce human contact with a fish during fish hook removal, comprises an elongated body, designed of wire which is controlled by a handle of cork or other floating material, which allows the angler to hold and control the wire or tubular stem, which terminates with a hook removing extraction loop. The extraction loop terminates in the form of a guiding flange. This fish hook remover is designed to allow the angler to slide the fish line, which has a fish attached to a hook on the end of the line, into a loop which can be guided down the line to the shank of the hook. Once the hook shank is engaged the angler can lift the fish hook remover and the fish is released.

### FIELD OF THE INVENTION

This invention relates to fishing, and to a fish hook remover for removing a fish hook, dressed as an artificial fly, from the mouth of a fish without having to handle, remove the fish from the water or damaging the artificial fly.

### BACKGROUND OF THE INVENTION

Fly fishing is a rapidly growing sport. Fishermen (anglers) use artificial bait in the form of a fish hook, designed to look like a living insect, by the use of fur, feathers or similar construction material being wrapped around the hook. (See Exhibit B-5). The artificial fly is cast into the water to attract and hook the fish.

As fly-fishing gains in popularity, increasing numbers of lakes and streams are being designated as “catch and release” only areas. This requires the fisherman to release the fish back into its environment (the water) without causing trauma. In addition, there are a growing number of anglers that believe the future of the sport will be determined by the sensitive attention to the number of fish that survive in the waters. Fly-fishing, together with extensive environmental threats, is greatly reducing the number of fish available to catch. Almost all fisheries around the world are experiencing reduced numbers of fish. Agricultural toxins, pollutants caused by carbon deposits, and other toxic substances are being delivered to the fisheries by rain, runoff, diversion of waterways and transference of water samples and chemicals by man and other animals. In addition, mankind's reliance on fish as a basic food source has caused the growth of commercial fishing, which in turn has greatly reduced the population of fish. Anglers believe that sensitively releasing fish after they have been caught is a practical and partial solution to this reduction of the fish population.

In “catch and release” fishing, the health of the fish after the release becomes a key issue. If executed with care, the mortality rate of caught fish is greatly reduced.

In order to insure the highest chances of survival for the fish, it is desirable to catch and then release the fish underwater, with as little physical contact between the fisherman and the fish as possible. It is also desirable to remove the fly from the fish without damaging the fly.

Existing fish hook removers provide options that require handling the fish, twisting the hook within the fish's mouth, removing the fish from the water, or pushing the hook further into the fish's mouth before removal can be accomplished. Fish that are caught by fly-fishermen are normally hooked around the exterior of the mouth . . . or by the ‘lips’ of the fish. A fish hook remover designed for fly-fishing therefore need not reach deep into the fish's throat to facilitate removal.

In addition, existing fish hook removers require the fishing line to be carefully aliened to a tube or chamber that requires time and dexterity that slows the release process . . . and further endangers the life of the fish. It is the opinion of some that tubes or chambers, often found in other fish hook removers, often damage the artificial fly.

Therefore, a better solution is needed to provide an improved fish hook remover, designed specifically to address the needs of a fly fisherman fishing in a catch and release area, or those inclined to release fish rather than keep them. More specifically, a better solution is needed to allow fishermen to more quickly and easily insert the line into a releasing device.

Accordingly, it is an object of the present invention to provide an improved fish hook remover.

### SUMMARY OF THE INVENTION

The aforementioned deficiencies are addressed by the present invention specifically by the uniquely designed loop flange (7); eliminate or reduce damage to the fly during removal . . . addressed by the release loop design (4); withdraw the hook from the fishes mouth with greater simplicity and impact upon the fish . . . addressed by the release loop design (4); and eliminate the necessity of handling a fish or remove it from the water to remove a fish hook. The fish hook remover of the present invention enables a fly fisherman to easily engage and remove a fish hook, dressed as an artificial fly, from a fish without handling the fish. There is no requirement to force the hook further into the fish's mouth. In this way, the fisherman doesn't have to handle the fish, and in a catch-and-release situation, the fisherman doesn't need to use a fishing net, glove or remove the fish from the water.

It is a further object of the present invention to provide a fish hook remover that minimizes damage to an artificial fly.

An additional object of the present invention is to provide a fish hook remover that enables a user to remove a fish hook from a fish without handling the fish or removing the fish from the water.

An additional object of the present invention is to provide a fish hook remover that floats in the water should it be dropped during the course of use or while the angler is in or near the fishing water.

Further objects and advantages of the present invention will become apparent from a consideration of the drawings and ensuing description.

### BRIEF DESCRIPTION OF THE DRAWINGS

Exhibit A:

Exhibit A shows a side view of a preferred embodiment of the fish hook remover of the present invention comprising an elongated body with an attaching loop (3) leading to a floating handle (2) which secures the guide stem (1) which in turn forms the releasing loop (4). The releasing loop (4) terminates by forming the guiding loop flange (7).

Exhibit B:

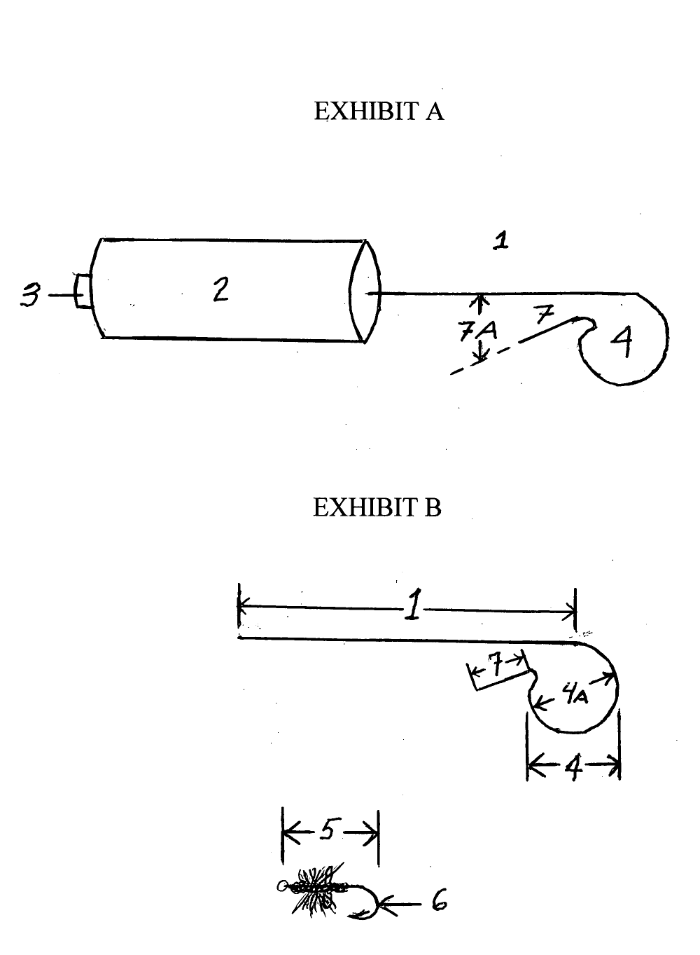

Exhibit B (FIG. 1) shows a close-up view of the guide stem (1) which in turn forms the releasing loop (4). The diameter of the releasing loop is noted as 4A. This close-up view also shows the formation of the guiding loop flange (7) as it terminates from the releasing loop structure.

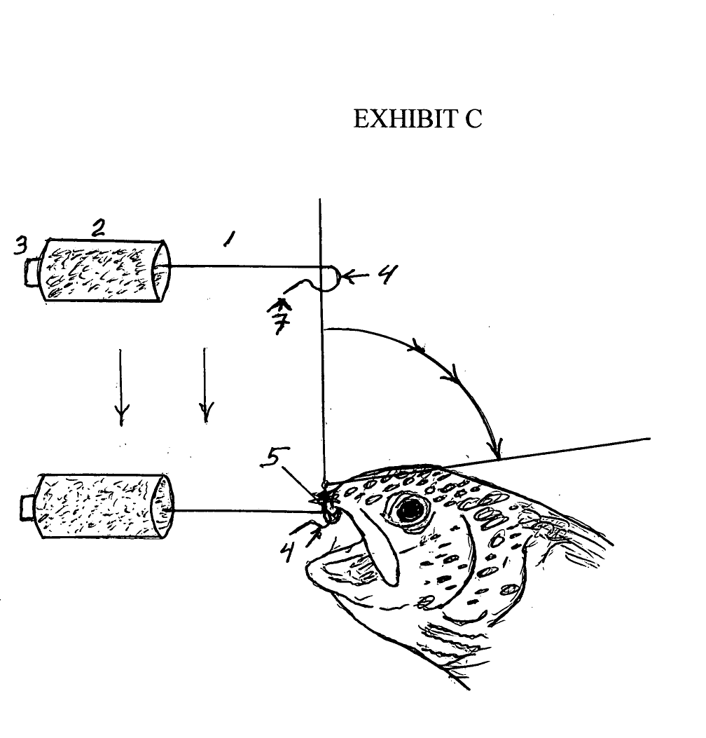

Exhibit B (FIG. 2) shows a close-up depiction of an artificial fly/hook (5) and the shank of this artificial fly/hook (6)

Exhibit C:

Exhibit C (FIG. 1) demonstrates the fish hook remover being applied to the fishing line in preparation to sliding down to the hook shank (6).

Exhibit C (FIG. 2) demonstrates the releasing loop (4) being engaged at the hook shank (6) in preparation for the extraction of the hook (5).

### DETAILED DESCRIPTION OF A PREFERRED EMBODIMENT

Exhibit A and Exhibit B provide a side view and a perspective view of a fish hook remover and a close up view of the present invention.

In a preferred embodiment, the handle (2) is constructed of cork and is of cylindrical tubular form. It is understood that the form or shape of this handle may be different as long as it fits the anglers hand and allow he/she to control the loop guide and resulting releasing loop. It is to be understood that various other materials may be used to construct this handle including but not limited to wood, plastic, Styrofoam or any other floating material that is buoyant and has the ability to float the fish hook remover in the event it is dropped into water. However, while it is preferred that this fish hook remover be able to float when in water, the handle (2) of this fish hook remover may be constructed of any material which includes materials that may not float nor have the ability to cause the fish hook remover to float.

In a preferred embodiment, the attaching loop (3) is formed by redirecting the guide stem back into the handle through a bending process that forms the attaching loop. It is to be understood that this attaching loop (3) may be created and attached through other options including a separate screw eye attachment, external loop attachment, or a non-loop formed additional embodiment that allows the angler to attach the fish hook remover to another material, tool or object. In addition, the attaching loop (3) may be removed or not attached which would still enable the fish hook remover to be constructed without an attaching loop option.

In a preferred embodiment the guide stem (1) is formed of a wire like material. It is to be understood that this guide stem structure (1) may be constructed or formed with the use of many kinds of wire including copper, stainless steel, iron, or other materials including plastic, wood, and metal. While the preferred embodiment of the guide stem (1) is depicted as a round tubular formed wire, the shape may be of other forms including square, rectangular or oval. The guide stem (1) is also noted as a specific length, relative in proportion to the handle and loop. The length of the guide stem (1) can be longer or shorter than depicted in the drawing.

In a preferred embodiment the releasing loop (4) is depicted as an open circular formed loop. It is to be understood that the shape of the releasing loop (4) may vary and could be constructed in the shape of a square, oval, circle, rectangle or combinations of these shapes.

In a preferred embodiment the releasing loop (4) is depicted as forming an open loop. It is to be understood that the releasing loop's opening may be of any size.

In a preferred embodiment the releasing loop (4) is noted to be of a specific size or diameter relative to the size or length of the stem, and the size and length of the handle.

It is understood that the diameter or dimension of the loop may be larger or smaller than that depicted.

In a preferred embodiment the guiding loop flange (7) the loop extends to form this flange and that the angle (7a) this flange forms, relative to the guide stem (1) is approximately forty five (45) degrees. It is to be understood that this angle (7a) may be larger or smaller than 45 degrees. In addition, the length of the guiding loop flange (7) may be shorter or longer than the depicted preferred embodiment.

Manufacturing Procedures:

Considering the perfect embodiment of the fish hook remover described above, a wire is initially shaped to form the releasing loop (4). The straight end of the wire is then inserted through the cork handle (2) and bent in a “U” shape to form the attaching loop (3). The wire is then pulled back through the cork handle to engage the attaching loop (3) back to the surface of the cork handle (2) which closes the attaching loop (3) to the surface of the cork handle.

Instructions for Use:

Securing the fishing line with one hand, approximately one to two feet above the caught fish, the fisherman guides the line/leader to the fish hook releasing stem (1). The line is directed down the releasing stem (1), and is forced into the releasing loop (4) by the guide flange (7). The fish hook remover is then guided down the fishing line/leader, over the fly's tackle (5) to the shank (6) of the hook. Keeping the line taught and parallel to the surface of the water, the angler slightly raises the fish hook remover, which is still attached to the shank of the hook (6), inverting the angle of the hook which results in the release of the fish.

What is claimed is:

1. The fish hook remover of claim 1, wherein said wire or fabricated releasing stem (1) is inserted through or attached to any floating material which comprises the handle (2).

2. The fish hook remover of claim 2, wherein said handle (2) may be of any shape that comfortably fits the anglers hand and allows the angler to control the direction and actions of the releasing stem (1) and ultimately the releasing loop (4). The handle is constructed with any floating material (presently depicted in a tubular shape) that will allow the fish hook remover to float if dropped into the water.

3. The fish hook remover of claim 3, further comprising a handle, attached to and/or securing the fabricated releasing stem (1), that terminates or forms a smaller loop and/or attached ring (3) that will allow the angler to attach the fish hook remover to another fastening device, material or tool.

4. The fish hook remover of claim 4, further comprising a releasing stem (1) that may be of any length that assists the angler in reaching the fish line and/or fish hook/fly.

5. The fish hook remover of claim 5, wherein said releasing stem (1) is constructed of a ridged material that is able to withstand the stresses inherent with the pressures applied by the weight and movement of the caught fish. This material may be of metal wire or other fabricated construct.

6. The fish hook remover of claim 6, wherein said releasing stem (1) extends to a releasing loop (4) that may be of any diameter size (4a) which allows the releasing loop to slide over the fly's tackle (5) to the shank (6) of the hook/fly.

7. The fish hook remover of claim 7, wherein said releasing loop terminates with a guiding flange (7) which directs the fishing line or leader into the releasing loop. This flange shall be angled (7a) outward from the releasing stem; but said angle is of a variable nature as long as the flange (7) assists the guidance of the fishing line down the releasing stem into the loop (4). The guiding flange is unique in its ability to allow the freedom of directing the line or leader to the releasing loop with great ease.
